(19) United States
(12) Patent Application Publication
(10) Pub. No.: US 2004/0111263 A1
(43) Pub. Date: Jun. 10, 2004

(54) Method of creating acoustic model and speech recognition device

(75) Inventors: Masanobu Nishitani, Shiojini-shi (JP); Yasunaga Miyazawa, Okaya-shi (JP); Hiroshi Matsumoto, Nagano-shi (JP); Kazumasa Yamamoto, Nagano-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/663,809

(22) Filed: Sep. 17, 2003

(30) Foreign Application Priority Data
Sep. 19, 2002 (JP) 2002-273071

(51) Int. Cl. G10L 15/00

(52) U.S. Cl. 704/256

(57) ABSTRACT

The invention provides an acoustic model creating method that can reduce the number of parameters and optimize the Gaussian distribution number for respective states constituting an HMM in order to create an HMM having high recognition ability. HMM sets in which the Gaussian distribution numbers of the respective states constituting the respective syllable HMMs are set from one to the maximum distribution number (the distribution number of which is 64) is trained using training speech data, and the respective states of the respective HMMs are viterbi-aligned with the training speech data corresponding to the HMMs using a syllable HMM set to the maximum distribution number among the trained syllable HMM sets. Then, a description length computing unit computes a description length for the respective states of the respective HMMs using the alignment data, and a state selecting unit selects a state having the distribution number the description length of which is minimum. Then, the respective HMMs are constructed in accordance with the states having the distribution numbers the description length of which is minimum, and an HMM retraining unit retrains these HMMs using the training speech data.

### BACKGROUND OF THE INVENTION

1. Field of Invention

The present invention relates to an acoustic model creating method of creating a Continuous Mixture Density HMM (Hidden Markov Model) as an acoustic model, and a speech recognition device using the acoustic model.

2. Description of Related Art

In speech recognition, a method of connecting phoneme HMMs or syllable HMMs to recognize speech, which is composed of words, clauses, and sentences, using the phoneme HMMs or the syllable HMMs as acoustic models, has been generally used. Specifically, Continuous Mixture Density HMMs have been widely used as the acoustic models since they have higher recognition performance.

In general, an HMM is composed of one to ten states and state transitions therebetween. In computation of the appearance probability of a symbol (speech feature vector at a predetermined time) in each state, as the Gaussian distribution number increases, the recognition accuracy increases in the mixed continuous distribution type HMM. However, there is a problem that as the Gaussian distribution number increases, the number of parameters increases, and then the amount of computational and/or memory resources required also increases. This can be a serious problem specifically when the speech recognition function is added to an inexpensive apparatus that uses a memory of small capacity or a processor having a low processing ability.

Further, in the general Continuous Mixture Density HMM, since the Gaussian distribution numbers in the all states of all the phoneme (or syllable) HMMs are the same, there is a problem in that over-training occurs in the phoneme (or syllable) HMM having little training speech data, and thus the recognition performance becomes low in the relevant phoneme (syllable).

As described above, in the Continuous Mixture Density HMM, it is general that the Gaussian distribution numbers are constant in the all states of each of the phonemes (or syllables), and a predetermined number of the Gaussian distribution in each state is required for improving the recognition accuracy. However, as described above, since there is a problem in that as the Gaussian distribution number increases, the number of parameters increases, and thus the amount of computational and/or memory resources that are required also increases. Thus, it is currently difficult to significantly increase the Gaussian distribution number.

Therefore, in the phoneme (or syllable) HMM, it has been considered to make the Gaussian distribution number different for every state, that is, the Gaussian distribution number is optimized for every state. For example, considering that the state largely affecting the recognition and the state not largely affecting the recognition exist in each state constituting a predetermined syllable HMM, it can be considered that the Gaussian distribution number increases for the states largely affecting the recognition and the Gaussian distribution number decreases for the states not largely affecting the recognition.

As described above, an example of the technology of optimizing the Gaussian distribution number for every state in the phoneme (or syllable) HMM is disclosed in “HMM Size Reduction Using MDL Creterion”, Lecture Miscellany of Acoustic Society of Japan, March in 2002, pp. 79 to 80, published in Spring Research Presentation in 2002 by Koichi Shinoda and Kenichi Iso.

### SUMMARY OF THE INVENTION

This conventional technology discloses that in each state, the Gaussian distribution number is reduced for the state not largely affecting the recognition. In brief, the HMMs having the large Gaussian distribution number, which has trained by sufficient training speech data, are prepared, and a tree structure of the Gaussian distribution number is created for every state. Then, a set of the Gaussian distribution numbers, in which the Minimum Description Length criterion (MDL: Minimum Description Length) becomes minimum for every state, is selected.

According to this conventional technology, it is possible to effectively and surely reduce the Gaussian distribution number for every state in the phoneme (or syllable) HMM and to optimize the Gaussian distribution number in each state. As a result, it is possible to reduce the number of parameters by the reduction of the Gaussian distribution number and also to maintain a high recognition rate.

However, in this conventional technology, the tree structure of the Gaussian distribution numbers is created for every state and the Gaussian distribution set (combination of the nodes) making the MDL criterion minimum selected from the tree structure of the distribution numbers. Thus, the number of the combinations of nodes for obtaining the optimal Gaussian distribution number in a predetermined state is considerably large, and thus it is necessary to perform many operations for computing the description length for every combination.

Furthermore, in the MDL criterion, the description length li(χ^{N}), which uses a model i when a model set {1, . . . , i, . . . , I} and data χ^{N}={χ₁, . . . , χ_{N}} are given, is defined as Equation 1:

$${l}_{i} ( {x}^{N} ) = - log {P}_{\hat{θ} ( i )} ( {x}^{N} ) + \frac{{β}_{i}}{2} log N + log I$$

θ(i): parameter of model i

θ⁽ⁱ⁾=maximum likelihood estimate of θ₁⁽ⁱ⁾, . . . , θ_{βi}⁽ⁱ⁾

βi: dimension (degree of freedom) of model i

In the MDL criterion, the model, the description length li(χ^{N}) of which is minimum, is considered to be the optimal model, but in this conventional technology, the combinations of the nodes may increase considerably. Therefore, when selecting the optimal Gaussian distribution set, the description length of the Gaussian distribution set composed of the combinations of nodes is computed using the description length computing equation approximating Equation 1. Like this, if the description length of the Gaussian distribution set composed of the combinations of node is computed by the approximate equation, it is considered that some problems may occur in the accuracy of the computed results.

It is an object of the present invention to provide an acoustic model creating method capable of creating an HMM, by which a high recognition performance is obtained with a small amount of computation, by enabling a Gaussian distribution number for each of the states in each phoneme (or syllable) HMM to be an optimal distribution number with excellent accuracy due to the smaller amount of computation using a MDL criterion, and to provide a speech recognition device applicable to an inexpensive system having the restrictions of hardware resources, such as computation ability or memory capacity, by using the acoustic model.

In order to accomplish the aforementioned object, an acoustic model creating method of creating an HMM by optimizing, for each state, Gaussian distribution numbers of the respective states constituting the HMM and retraining the optimized HMM using training speech data, the method comprising the steps of: setting plural types of the Gaussian distribution numbers from a predetermined value to a maximum distribution number for each of the plurality of states constituting the HMM; computing a description length for each of the plurality of states having the plural types of Gaussian distribution numbers using a Minimum Description Length criterion; selecting a state having the Gaussian distribution number whose the description length is minimum, for every state; and constructing the HMM in accordance with the state having the Gaussian distribution number whose the description length is minimum, selected for every state, and retraining the constructed HMM using the training speech data.

In this acoustic model creating method, for the Minimum Description Length criterion, a description length li(χ^{N}) using a model i when a model set {1, . . . , i, . . . , I} and data χ^{N}={χ₁, . . . , χ_{N}} (herein, N is a data length) are given is expressed as the following general equation,

$${l}_{i} ( {x}^{N} ) = - log {P}_{\hat{θ} ( i )} ( {x}^{N} ) + \frac{{β}_{i}}{2} log N + log I \qquad ( Equation 1 )$$

θ(i): parameter of model i

θ(i)=maximum likelihood estimate of θ₁⁽ⁱ⁾, . . . , θ_{βi}⁽ⁱ⁾

βi: dimension (degree of freedom) of model i

and in this general equation for computing the description length, the model set {1, . . . , i, . . . , I} is considered as a set of states in which plural types of the Gaussian distribution numbers from a predetermined value to the maximum distribution number are set for a predetermined state in a predetermined HMM, where, when the number of types of the Gaussian distribution number is I (I is an integer satisfying I≧2), then 1, . . . , i, . . . , I are symbols for specifying the respective distribution number types from a first type to an I-th type, and Equation 1 is used as an equation that computes the description length of the state having the i-th type of distribution number out of 1, . . . , i, . . . , I.

Furthermore, in the general equation that computes the description length, the second term on the right side of the equation can be multiplied by a weighting coefficient α.

Furthermore, in the general equation that computes the description length, the second term on the right side of the equation may be multiplied by the weighting coefficient α, and the third term on the right side may be omitted.

Furthermore, the data χ^{N} is a set of the respective training speech data obtained by matching in time series a plurality of the training speech data with the respective states of the HMM for every state, using the HMM in which the respective states have any one of the Gaussian distribution numbers from the predetermined value to the maximum distribution number. Furthermore, at that time, it is preferable that the any one of the Gaussian distribution numbers be the maximum distribution number.

Furthermore, when the HMMs are syllable HMMs, for a plurality of syllable HMMs having a same consonant or a same vowel, the syllable HMMs having the same consonant out of the states constituting the syllable HMMs may tie an initial state or at least two states including an initial state in the syllable HMMs, and the syllable HMMs having the same vowel may tie a final state of the states having self loops or at least two states including the final state in the syllable HMMs.

Furthermore, a speech recognition device of the present invention recognizes input speech using HMMs (Hidden Markov Models) as acoustic models for feature data obtained by feature analysis of the input speech. The HMMs created by the aforementioned acoustic model creating method can be used as the HMMs which are the acoustic models.

Like this, in the present invention, in order to optimize the Gaussian distribution number (hereinafter, simply referred to as distribution number) for every state, the Gaussian distribution numbers can be set to plural types of distribution numbers from a predetermined value to the maximum distribution number for each of a plurality of states constituting the HMM. As for the distribution numbers set from the predetermined value to the maximum distribution number, it is selected which of the Gaussian distribution numbers from the predetermined value to the maximum distribution number is optimum using the Minimum Description Length criterion. The respective HMMs are constructed in accordance with the selected states having the distribution numbers the description length of which is minimum, and each of the constructed HMMs is retrained using the training speech data. By doing so, it is possible to set the optimum distribution numbers with a small amount of computation, and it is also possible to create the HMMs capable of obtaining high recognition ability with the smaller amount of computation.

Specifically, in the present invention, a state having the optimum distribution number is selected from the distribution numbers from the predetermined value to the maximum distribution number. Therefore, for example, when the number of types of the distribution numbers in a predetermined state is set to seven, the computation for computing the description length is performed seven times in one state, and then the state the description length of which is minimum is selected from them. Thus, one feature of the present invention is that it is possible to set the optimum distribution number with a small amount of computation.

Furthermore, in the present invention, the model set {1, . . . , i, . . . , I} of the MDL criterion is considered as a set of states in which the Gaussian distribution numbers of a predetermined state in a predetermined HMM are set to the plural types from a predetermined value to the maximum distribution number, and Equation 1 is used as an equation that computes the description length of the state having the type of i-th distribution number out of the 1, . . . , i, . . . , I. Thus, when the distribution numbers in the predetermined state are set to various types of distribution numbers from the predetermined value to the maximum distribution number, the description length of the state set by each of the distribution numbers can be easily computed. In addition, the optimum distribution number in that state can be set by obtaining the distribution number the description length of which is minimum from the computed results.

Furthermore, in the general equation that computes the description length, the second term on the right side of the equation can be multiplied by the weighting coefficient α. Therefore, by varying the weighting coefficient α, it is possible to vary the slope of the monotone increasing of the second term (the slope increases as α increases) and to vary the description length li(χ^{N}). Thus, as α increases, it is possible to adjust the description length li(χ^{N}) to the minimum value when the distribution number is smaller.

Furthermore, in the general equation that computes the description length, it is possible to further simplify the computation of the description length by multiplying the second term on the right side of the equation by the weighting coefficient α and omitting the third term on the right side indicating a constant.

Furthermore, a predetermined state of the HMM is aligned in time series (for example, the viterbi alignment is performed) with the plural training speech data corresponding to the HMM using the HMM in which each of the states has any one of the distribution numbers, and the set of the training speech data corresponding to the aligned intervals is used as the data χ^{N} of Equation 1. Like this, the description length is computed using as the data χ^{N} of Equation 1 the training speech data, which is obtained by using the HMM in which each of the states has any one of the distribution numbers and by aligning in series each of the states of the HMM with the plural training speech data corresponding to the HMM. Thus, it is possible to obtain the description length with excellent accuracy.

At that time, since more accurate alignment can be performed by using the HMM in which each of the states has the maximum distribution number as the any distribution number, it is possible to obtain the description length with higher accuracy by using the alignment data for computing the description length.

Furthermore, it is preferable that the HMM be a syllable HMM, and in the present invention, it is possible to reduce the amount of computation by using the syllable HMM. For example, when the number of syllables is 124, the number of syllables is larger than the number of phonemes (about 26 to 40) from the point of view of the number. However, since a triphone model may be often used as a unit acoustic model in the phoneme HMM and the triphone model is composed of one phoneme in consideration of the preceding and following phoneme environments of a predetermined phoneme, the number of models is several thousands in consideration of the all combinations, and then the syllable models have a much lower number of acoustic models.

For instance, in the syllable HMM, since the number of states constituting each syllable HMM is about five when the syllable includes consonants and is about three when the syllable includes only vowels, the total number of states is about 600. However, in the triphone model, the total number of states amounts to several thousands even if the state tying is performed between the models to reduce the number of states. For this reason, by using the syllable HMM as the HMM, it is possible to reduce the overall amount of computation as well as the amount of computation for obtaining the description length, and it is also possible to obtain the recognition accuracy as compared favorably with the triphone model.

Furthermore, when the HMM is the syllable HMM, as for a plurality of syllable HMMs having the same consonant or the same vowel, the syllable HMMs having the same consonant out of the states constituting the syllable HMMs tie an initial state or at least two states including an initial state in the syllable HMMs, and the syllable HMMs having the same vowel tie a final state of the states having self loops or at least two states including the final state in the syllable HMMs. Thus, it is possible to further reduce the number of parameters. As a result, it is possible to reduce the amount of computation and the required memory capacity and to increase a processing speed, thereby lowering costs and power consumptions.

Furthermore, the speech recognition device of the present invention uses the acoustic model (HMM) created by the aforementioned acoustic model creating method of the present invention. That is, since the HMM can include the syllable models for respective syllables having the optimum distribution numbers for each of the plural states constituting the HMM, it is possible to substantially reduce the number of parameters in each syllable HMM without deteriorating the recognition ability as compared with the HMM in which all the states have the same distribution numbers. As a result, it is possible to reduce the amount of computation and the required memory capacity and to increase a processing speed, thereby lowering costs and power consumptions. Thus, it is considerably useful as a speech recognition device mounted to a small-sized and inexpensive system having large restrictions on hardware resources.

### BRIEF DESCRIPTION OF THE DRAWINGS

The invention will be described with reference to the accompanying drawings, wherein like numerals reference like elements, and wherein:

FIG. 1 is a view illustrating the order of creating an acoustic model according to a first embodiment of the present invention;

FIG. 2 is a view illustrating the creation of a syllable HMM set when the distribution numbers are set to seven types from one to the maximum distribution number (the distribution number of which is 64);

FIG. 3 is a view extracting from FIG. 1 and showing only the parts required for illustrating alignment data creating process in the acoustic model creating process shown in FIG. 1;

FIG. 4 is a view illustrating a specific example of a process of matching training speech data 1 with the respective states of the respective syllable HMMs in order to create alignment data;

FIG. 5 is a view extracting from FIG. 1 and showing only the parts required for illustrating a process of computing description lengths of the respective states of the respective syllable HMMs in the distribution numbers from one to the maximum in the acoustic model creating process shown in FIG. 1;

FIG. 6 is a view illustrating a state in which the description lengths of the respective states in the distribution numbers from one to the maximum in a syllable HMM of /a/ have been computed;

FIG. 7 is a view extracting from FIG. 1 and showing only the parts required for illustrating a state selecting process using an MDL criterion in the acoustic model creating process shown in FIG. 1;

FIG. 8 is a view illustrating a process of selecting the states the description length of which is minimum for the respective states S0, S1, S2 of each syllable HMM in the distribution numbers from one to the maximum using the MDL criterion;

FIG. 9 is a view illustrating a weighting coefficient α used in the first embodiment;

FIG. 10 is a view illustrating a schematic construction of a speech recognition device according to the present invention; and

FIG. 11 is a view illustrating a state tying which is a second embodiment of the present invention, and is also a view illustrating a case where an initial state or a final state (a final state of the states having a self loop) is tied in several syllable HMMs;

### DETAILED DESCRIPTION OF PREFERRED EMBODIMENTS

Now, embodiments of the present invention will be described.

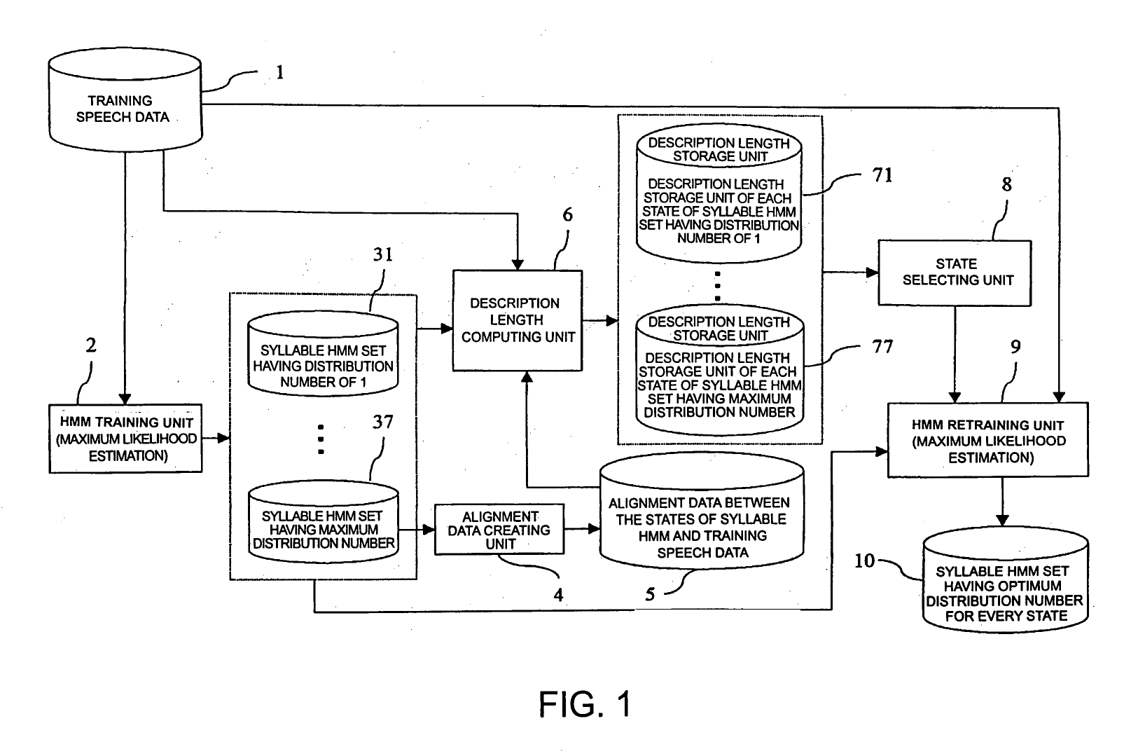

First, a first embodiment, in which in each syllable HMM, the distribution number is optimized for every state constituting the syllable HMM using an MDL criterion, will be described. Furthermore, the present invention can be applied to both phoneme HMMs and syllable HMMs, but the syllable HMMs will be described in the first embodiment. First, the schematic flow of the overall processes of the first embodiment will be described with reference to FIG. 1.

First, syllable HMM sets are created, in which the Gaussian distribution number of each state constituting each syllable HMM is set to have from a predetermined value to the maximum distribution number. In this embodiment, the distribution number includes the distribution number 1, the distribution number 2, the distribution number 4, the distribution number 8, the distribution number 16, the distribution number 32, and the distribution number 64.

That is, in this case, similar to a syllable HMM set having all the syllable HMMs the distribution number of which is 1, a syllable HMM set having all the syllable HMMs the distribution number of which is 2, and a syllable HMM set having all the syllable HMMs the distribution number of which is 4, seven kinds of syllable HMM sets having the aforementioned seven types of distribution numbers are created for every syllable. Furthermore, in this embodiment, the seven kinds of distribution number are described, but it is not limited to the seven kinds. In addition, each of the distribution numbers is not limited to the values, such as 1, 2, 4, 8, 16, 32 and 64, and the maximum distribution number is not limited to 64.

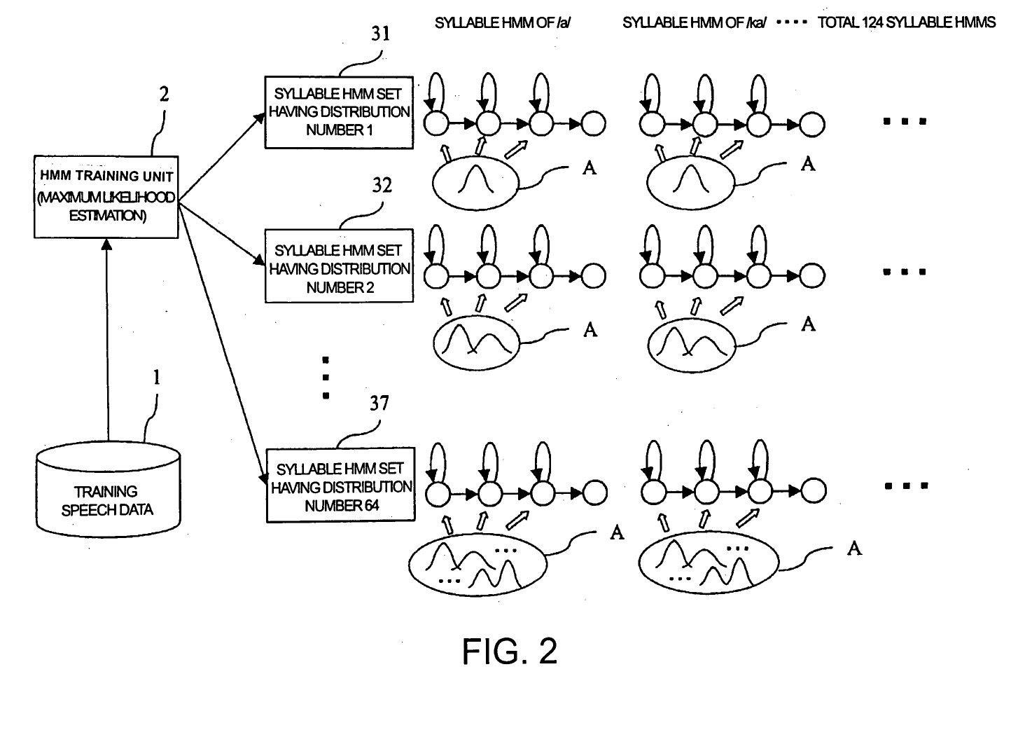

An HMM training unit 2 trains all the syllable HMMs included in the seven kinds of syllable HMM sets using a maximum likelihood estimation method for parameters of each syllable HMM, and the syllable HMMs completely trained from the distribution number 1 to the maximum distribution number are created. That is, in this embodiment, since the seven types of distribution numbers, such as the distribution number 1, the distribution number 2, the distribution number 4, . . . , the distribution number 64, are created, seven types of the trained syllable HMM sets 31 to 37 are created corresponding to them. These will be described with reference to FIG. 2.

The HMM training unit 2 trains each syllable HMM set, the distribution numbers of which are set to seven types of distribution numbers 1, 2, . . . , 64 for each syllable (herein, 124 syllables such as a syllable /a/, a syllable /ka/, . . . ), using training speech data 1 by the maximum likelihood estimation method, and creates the syllable HMM sets 31, 32, . . . , 37 for every distribution number. Furthermore, in this example, suppose that each syllable HMM has three self-loop states of S0, S1 and S2.

By doing so, the syllable HMMs trained for each syllable of 124 syllables, such as the syllable HMM of /a/, the syllable HMM of /ka/, and the like, exist in the syllable HMM set 31 the distribution number of which is 1. In addition, the syllable HMMs trained for each syllable of 124 syllables, such as the syllable HMM of/a/, the syllable HMM of /ka/, and the like, exist in the syllable HMM set 32 the distribution number of which is 2. Similar to the above cases, the syllable HMMs trained for each syllable of 124 syllables exist in each of the syllable HMMs 31, 32, . . . , 37 having the distribution number 1, the distribution number 2, the distribution number 4, . . . , the distribution number 64, respectively.

Furthermore, in FIG. 2, the Gaussian distributions within the elliptical frames A shown below each of the states S0, S1 and S2 of each of the syllable HMMs in the syllable HMM set 31 the distribution number of which is 1, the syllable HMM set 32 the distribution number of which is 2, . . . , the syllable HMM set 37 the distribution number of which is 64, illustrate distribution examples in the respective states, wherein the syllable HMM set 31 the distribution number of which is 1 has one distribution for all the syllable HMMS, the syllable HMM set 32 the distribution number of which is 2 has two distributions for all the syllable HMMs, and the syllable HMM set 37, the distribution number of which is 64, has 64 distributions for all the syllable HMMs.

As described above, each of syllable HMM sets 31 to 37 corresponding to the seven types of distribution numbers, which include the syllable HMM set 31 the distribution number of which is 1, the syllable HMM set 32 the distribution number of which is 2, . . . , the syllable HMM set the distribution number of which is maximum (in this case, the syllable HMM set 37 the distribution number of which is 64), is created by the training of the HMM training unit 2.

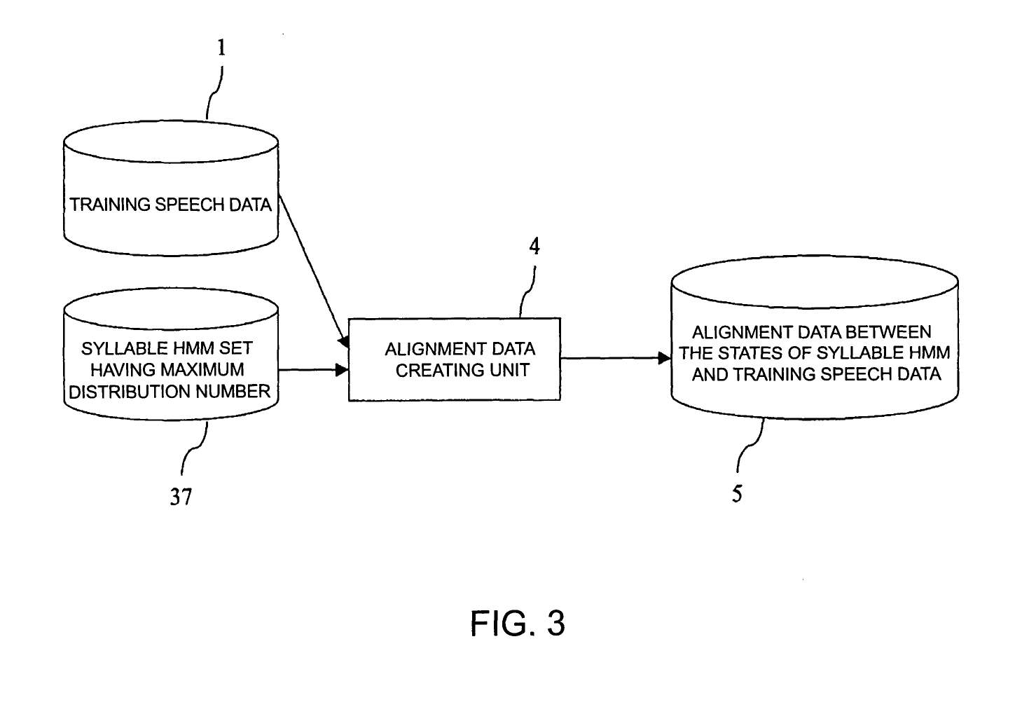

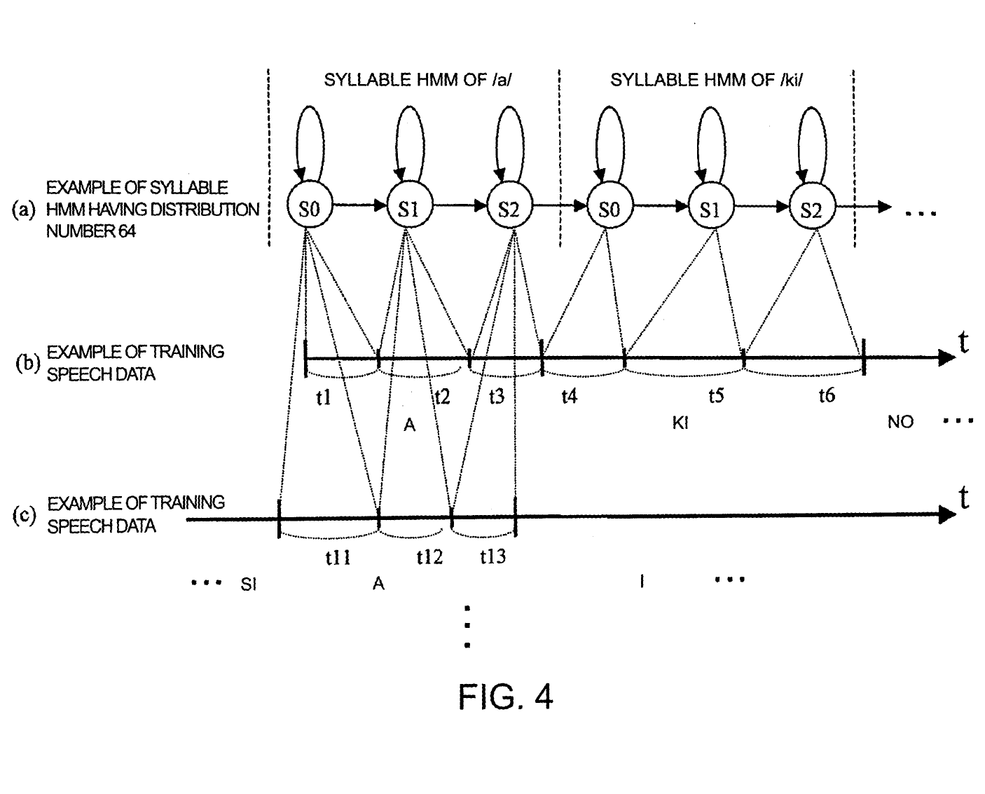

Next, returning to description of FIG. 1, the Viterbi alignment with all the training speech data 1 is taken by the alignment data creating unit 4 using any syllable HMM set (herein, the syllable HMM set 37 the distribution number of which is maximum, that is, 64) out of the syllable HMM set 31 the distribution number of which is 1, the syllable HMM set 32 the distribution number of which is 2, . . . , the syllable HMM set the distribution number of which is maximum (in this case, the syllable HMM set 37 the distribution number of which is 64), which are trained by the HMM training unit 2. Then, each state of each of the syllable HMMs is matched with the training speech data 1, and then the alignment data 5 between each state S0, S1 and S2 of the syllable HMM set 37 having the maximum distribution number (the distribution number of which is 64) and the training speech data 1 is created. The above operation will be described with reference to FIGS. 3 and 4.

FIG. 3 shows a view illustrating only the parts required for describing the alignment data creating process, which is extracted from FIG. 1, and FIG. 4 illustrates a specific example of a process in which the training speech data 1 is matched to each state of each of the syllable HMMs in order to create the alignment data.

As shown in FIGS. 4(a), 4(b) and 4(c), the alignment data creating unit 4 aligns each of the states of S0, S1 and S2 of the respective syllable HMMs in the syllable HMM set 37 the distribution number of which is 64 with the training speech data 1 corresponding to the syllables using all the training speech data 1 and the syllable HMM set having the maximum distribution number (in this case, the syllable HMM set 37 the distribution number of which is 64).

For example, as shown in FIG. 4(b), when the alignment is taken for an example of the training speech data of “AKINO (autumn) . . . ”, in each speech data interval corresponding to the training speech data “A”, “KI”, “NO”, . . . , the alignment is taken such that the state S0 in the syllable HMM of /a/, the distribution number of which is 64, corresponds to the interval t1 of the speech data of “A”, the state S1 in the syllable HMM of /a/ corresponds to the interval t2 of the speech data of “A”, and the state S2 in the syllable HMM of /a/ corresponds to the interval t3 of the speech data of “A”, and the corresponding data is set to the alignment data 5.

Similarly, the alignment is taken such that the state S0 in the syllable HMM of /ki/, the distribution number of which is 64, corresponds to the interval t4 of the speech data of “KI”, the state S1 in the syllable HMM of /ki/ corresponds to the interval t5 of the speech data of “KI”, and the state S2 in the syllable HMM of /ki/ corresponds to the interval t6 of the speech data of “KI”, and the corresponding data is set to the alignment data 5.

Furthermore, as shown in FIG. 4(c), paying attention to the portion of “A” among the portion corresponding to “SI”, the portion corresponding to “A”, and the portion corresponding to “I” in the training speech data of “SIAI (game) . . . ”, which is an example of the training speech data, the alignment is taken such that the state S0 in the syllable HMM of /a/, the distribution number of which is 64, corresponds to the interval t11 of the speech data of “A”, the state S1 in the syllable HMM of /a/ corresponds to the interval t12 of the speech data of “A”, and the state S2 in the syllable HMM of /a/ corresponds to the interval t13 of the speech data of “A”, and the corresponding data is set to the alignment data 5.

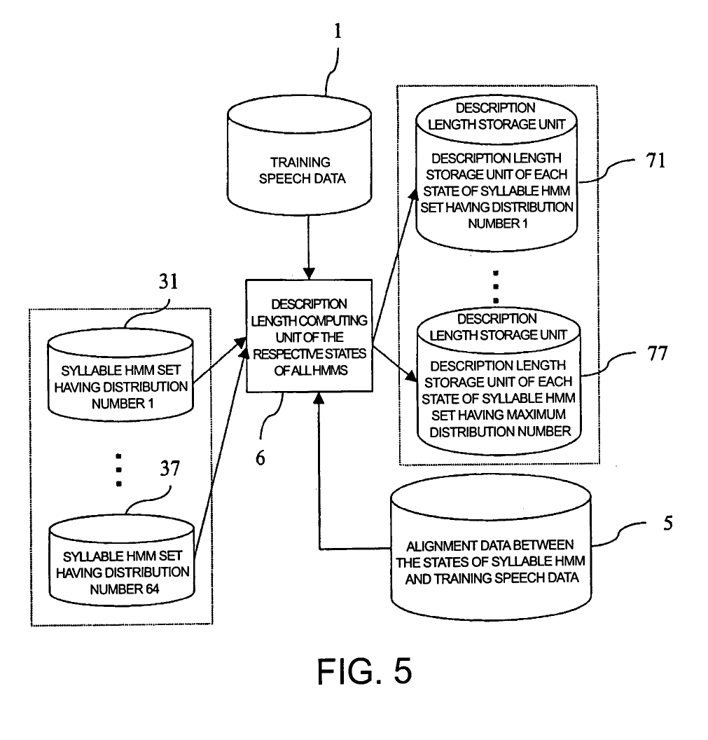

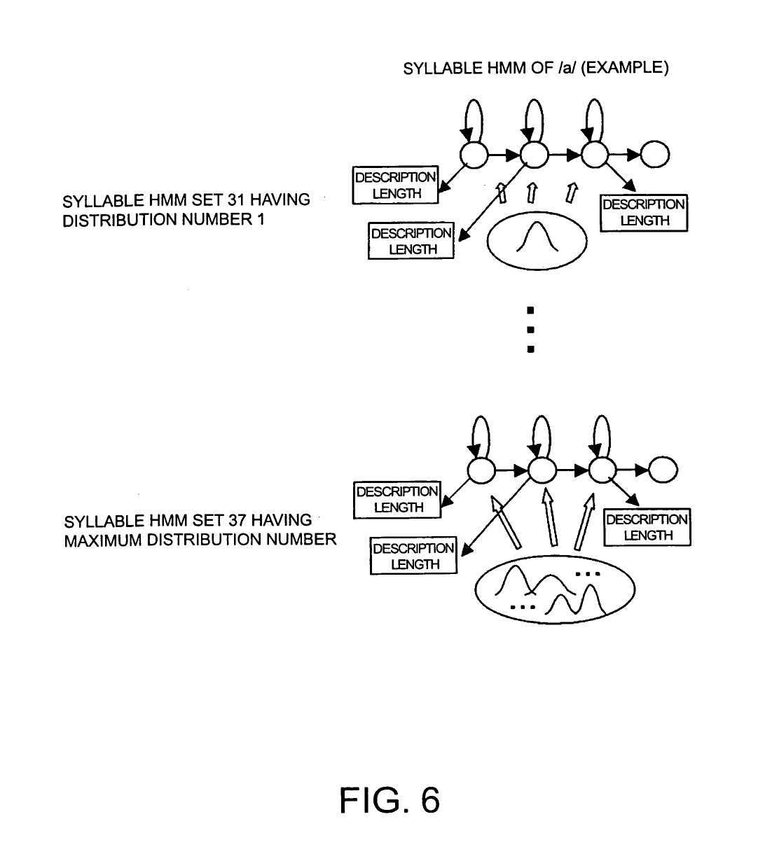

Next, the description length computing unit 6 shown in FIG. 1 computes the description lengths of the all states for the syllable HMM sets, which include from the distribution number 1 to the maximum distribution number (in this case, the respective syllable HMM sets 31 to 37 corresponding to the seven types of distribution numbers, such as the distribution number 1, the distribution number 2, the distribution number 4, . . . , the distribution number 64), using each state of each of the syllable HMMs in the syllable HMM set, the distribution number of which is 64, and the alignment data 5 of the training speech data, which are obtained by the alignment data creating unit 4. The above operation will be described with reference to FIGS. 5 and 6.

FIG. 5 shows a view illustrating only the parts required for describing the description length computing unit 6, which is extracted from FIG. 1, and the parameter of each of the syllable HMM sets, which include from the distribution number 1 to the maximum distribution number (in this case, the respective syllable HMM sets 31 to 37 having the distribution number 1, the distribution number 2, the distribution number 4, . . . , the distribution number 64), and the training speech data 1, and the alignment data 5 between each state of each of the syllable HMMs and the training speech data 1 are provided to the description length computing unit 6.

Then, the description length computing unit 6 computes the description length corresponding to each distribution number of each state in each of the syllable HMMs. As a result, the description length of each state in each syllable HMM of syllable HMM sets 31 to 37 corresponding to the seven types of distribution numbers, which include from the distribution number 1 to the maximum distribution number (the distribution number 64), is computed.

That is, referring to as the description length of each state in each syllable HMM of the syllable HMM set 31 the distribution number of which is 1, the description length of each state in each syllable HMM of the syllable HMM set 32 the distribution number of which is 2, the description length of each state in each syllable HMM of the syllable HMM set 33 the distribution number of which is 4, and the description length of each state in each syllable HMM of the syllable HMM set 37 the distribution number of which is 64, the description lengths including from the description length of each state in each syllable HMM of the syllable HMM set 31, the distribution number of which is 1, to the description length of each state in each syllable HMM of the syllable HMM set 37 the distribution number of which is 64, are computed, and the description lengths including from the description length 71 of each state in each syllable HMM of the syllable HMM set 31, the distribution number of which is 1, to the description length of each state in each syllable HMM of the syllable HMM set 37, the distribution number of which is 64, are stored in the description length storage units 71 to 77. Furthermore, the method of computing the description lengths will be described in greater detail below.

FIG. 6 illustrates a state in which the description lengths have been computed for each state S0, S1 and S2 of, for example, the syllable HMM of /a/, in the description lengths, which include from the description length (the description length of each state stored in the description length storage unit 71) of each state in each syllable HMM of the syllable HMM set, the distribution number of which is 1, to the description length (the description length of each state stored in the description length storage unit 77) of each state in each syllable HMM of the syllable HMM set, the distribution number of which is maximum (the distribution number is 64), which are obtained from FIG. 5.

As known from FIG. 6, the description length is computed for the states S0, S1 and S2 of the syllable HMM of /a/ of the distribution number 1, the description length is computed for the states S0, S1 and S2 of the syllable HMM of /a/ of the distribution number 2, and the description length is computed for the states S0, S1 and S2 of the syllable HMM of /a/ of the distribution number 64. Thus, the description lengths of the respective states S0, S1 and S2 are computed for the syllable HMMs of /a/ corresponding to the seven types of distribution numbers, which include from the distribution number 1 to the maximum distribution number (the distribution number 64). Furthermore, only the syllable HMMs of /a/ of the distribution number 1 and the maximum distribution number (the distribution number 64) among the seven types of distribution numbers are shown in FIG. 6.

Similar to the other syllables, the description length of each of the states S0, S1 and S2 is computed for each of the syllable HMMs corresponding to the seven types of distribution numbers from the distribution number 1 to the maximum distribution number (the distribution number 64).

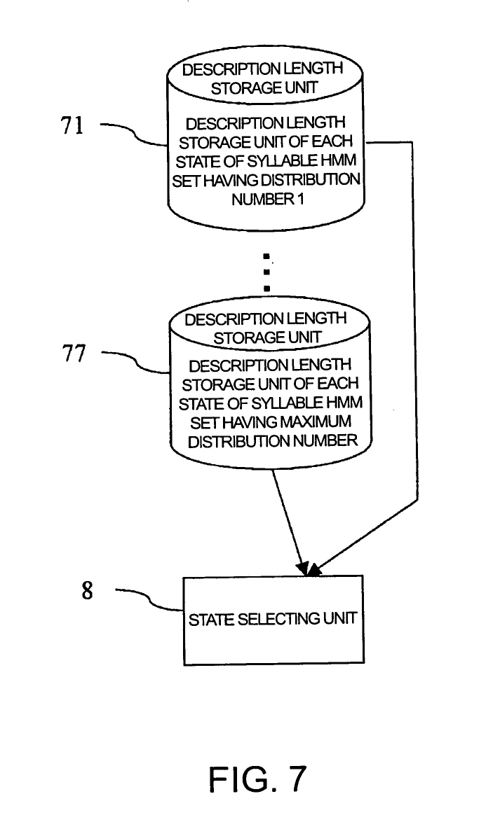

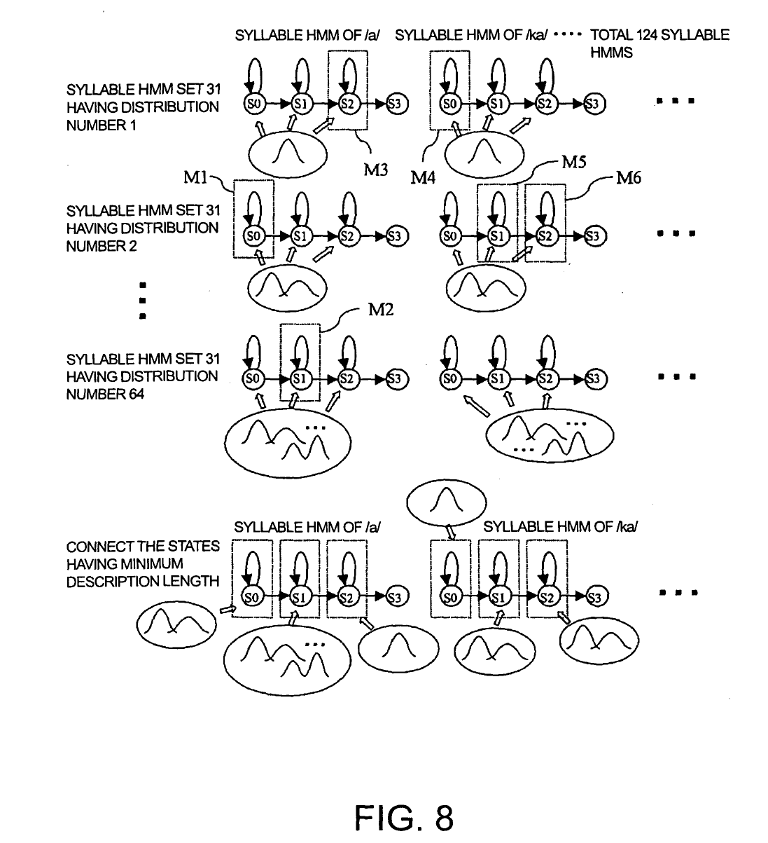

Next, the state selecting unit 8 selects a state having the distribution number, in which the description length of each state of each syllable HMM is minimum, for every syllable HMM using the description lengths, which include from the description length of each state of the syllable HMM set 31, the distribution number of which is 1, to the description length of each state of the syllable HMM set 37 the distribution number of which is maximum (the distribution number 64), which are computed by the aforementioned description length computing unit 6. The above operation will be described with reference to FIGS. 7 and 8.

FIG. 7 shows only the parts required for illustrating the state selecting unit 8 and is extracted from FIG. 1. As for the description lengths including the range from the description length (the description length of each state stored in the description length storage unit 71) of each state in the syllable HMM set 31, the distribution number of which is 1, to the description length (the description length of each state stored in the description length storage unit 77) of each state in the syllable HMM set 37, the distribution number of which is maximum (the distribution number is 64), computed by the description length computing unit 6, it is determined which of the respective states S0, S1 and S2 in the respective syllable HMMs of the distribution numbers 1 to 64has the minimum description length, and the state of the distribution number having the minimum description length is selected.

Herein, as for the syllable HMMs of /a/ and the syllable HMMs of /ka/, it is determined which of the respective states S0, S1 and S2 in the respective syllable HMMs corresponding to the seven types of distribution numbers 1 to 64(maximum distribution number) has the minimum description length. The process of selecting the state having the distribution number the description length of which is minimum will be described with reference to FIG. 8.

First, as for the states S0 of the syllable HMMs of /a/, suppose that it is determined that the state S0 having the distribution number 2 has the minimum description length as a result of being determined which of the respective states S0 of the distribution numbers 1 to 64has the minimum description length. This is denoted by a rectangular frame M1 shown in a dotted line.

Furthermore, as for the states S1 in the syllable HMMs of /a/, suppose that it is determined that the state S1 of the distribution number 64has the minimum description length as a result of being determined which of the respective states S1 of the distribution numbers 1 to 64has the minimum description length. This is denoted by a rectangular frame M2 shown in a dotted line.

Furthermore, as for the states S2 in the syllable HMMs of /a/, suppose that it is determined that the state S2 of the distribution number 1 has the minimum description length as a result of being determined which of the respective states S2 of the distribution numbers 1 to 64has the minimum description length. This is denoted by a rectangular frame M3 shown in a dotted line.

As described above, as for the syllable HMMs of /a/, when determining which of the respective states S0, S1 and S2 of the distribution numbers 1 to 64(maximum distribution number) has the minimum description length to select the state having the minimum description length, the state S0 of the distribution number 2 is selected from the states S0, the state S1 of the distribution number 64is selected from the states S1 , and the state S2 of the distribution number 1 is selected from the states S2. Therefore, the syllable HMM of /a/ is constructed connecting them.

The syllable HMM of /a/ composed of the states having the minimum description length, where the state S0 has the distribution number 2, the state S1 has the distribution number 64, and the state S2 has the distribution number 1, becomes a syllable HMM of /a/ obtained by connecting the states the distribution numbers of which are optimized.

Similarly, as for the states S0 in the syllable HMMs of /ka/, suppose that it is determined that the state S0 of the distribution number 1 has the minimum description length as a result of being determined which of the respective states S0 of the distribution numbers 1 to 64 has the minimum description length. This is denoted by a rectangular frame M4 shown in a dotted line.

Furthermore, as for the states S1 in the syllable HMMs of /ka/, suppose that it is determined that the state S1 having the distribution number 2 has the minimum description length as a result of being determined which of the respective states S1 of the distribution numbers 1 to 6 has the minimum description length. This is denoted by a rectangular frame M5 shown in a dotted line. Furthermore, as for the states S2 in the syllable HMMs of /ka/, suppose that it is determined that the state S2 having the distribution number 2 has the minimum description length as a result of being determined which of the respective states S2 of the distribution numbers 1 to 64 has the minimum description length. This is denoted by a rectangular frame M6 shown in a dotted line.

As described above, as for the syllable HMMs of /ka/, when determining which of the respective states S0, S1 and S2 of the distribution numbers 1 to 64 (maximum distribution number) has the minimum distribution number to select the state having the minimum description length, the state S0 having the distribution number 1 is selected from the states S0, the state S1 having the distribution number 2 is selected from the states S1 , and the state S2 having the distribution number 2 is selected from the states S2. Therefore, the syllable HMM of /ka/ is constructed connecting them.

The syllable HMM of /ka/ composed of the states having the minimum description lengths (wherein the state S0 has the distribution number 1, the state S1 has the distribution number 2 and the state S2 has the distribution number 2) becomes a syllable HMM of /ka/ obtained by connecting the states having the optimum distribution numbers.

By performing such processes on the all syllable HMMs (herein, 124 syllables), the respective syllable HMMs are composed of the states having the minimum description lengths. Therefore, the HMMs having the optimum distribution numbers are constructed.

By doing so, when the HMM having the optimized distribution numbers is constructed for every state, the HMM retraining unit 9 (see FIG. 1) retrains all parameters of the HMM having the optimized distribution numbers using the training speech data 1 by the maximum likelihood estimation method. By doing so, the syllable HMM set 10 can be obtained for each syllable HMM, wherein the syllable HMM set 10 has the optimized distribution numbers for every state, and has the optimum parameters for every state.

Next, the MDL (Minimum Description Length) criterion used in the present invention will be described. The MDL criterion is a known technology, which is disclosed, for example, in “Iwanami Lecture Applied mathematics 11, Mathematical Principle of Information and Encoding” by Tae-sun Han, Iwanami Bookstore (1994), pp. 249 to 275. As described in the conventional technology, the description length li(χ^{N}) using the model i when the model set {1, . . . , i, . . . , I} and the data χ^{N}={χ₁, . . . , χ_{N}} (where N is a data length) are given is defined as the aforementioned Equation 1, and the model the description length li(χ^{N}) of which is minimum is referred to as the optimal model.

In the present invention, the aforementioned model set {1, . . . , i, . . . , I} is considered as a set of predetermined states the distribution numbers in a predetermined HMM of which are set to a plurality of types from a predetermined number to the maximum number. Furthermore, supposed that a plurality of the distribution numbers from the predetermined value to the maximum number, that is, I types of distribution numbers (I is an integer satisfying I≧2) exist, the aforementioned 1, . . . , i, . . . , I are the symbols for specifying the respective types from the first type to I-th type, and the aforementioned Equation 1 is used as an equation for computing the description length of the state having the i-th distribution number out of 1, . . . , i, . . . , I.

Furthermore, I of 1, . . . , i, . . . , I denotes the total number of the HMM sets having the distribution numbers different from each other, that is, what types of distribution numbers exist, and in this embodiment, since the distribution numbers are set to the seven types of 1, 2, 4, 8, 16, 32 and 64, I=7.

Like this, since 1, . . . , i, . . . , I are symbols for specifying the respective types from the first type to I-th type, in this embodiment, 1 of 1, . . . , i, . . . , I is given to the distribution number 1 as a symbol for denoting the type of the distribution number, and it is indicated that the type of the distribution number is the first. Furthermore, 2 of 1, . . . , i, . . . , I is given to the distribution number 2 as a symbol for denoting the type of the distribution number to indicate that the type of the distribution number is the second. Furthermore, 3 of 1, . . . , i, . . . , I is given to the distribution number 4 as a symbol for denoting the type of the distribution number to indicate that the type of the distribution number is the third. Furthermore, 4 of 1, . . . , i, . . . , I is given to the distribution number 8 as a symbol for denoting the type of the distribution number to indicate that the type of the distribution number is the fourth. Furthermore, 5 of 1, . . . , i, . . . , I is given to the distribution number 16 as a symbol for denoting the type of the distribution number to indicate that the type of the distribution number is the fifth. Furthermore, 6 of 1, . . . , i, . . . , I is given to the distribution number 32 as a symbol for denoting the type of the distribution number to indicate that the type of the distribution number is the sixth. Furthermore, 7 of 1, . . . , i, . . . , I is given to the distribution number 64 as a symbol for denoting the type of the distribution number to indicate that the type of the distribution number is the seventh.

Considering the syllable HMMs of /a/, as shown in FIG. 8, a set of states S0 having the seven types of distribution numbers from the distribution number 1 to the distribution number 64 is one model set. Similarly, a set of states S1 having the seven types of distribution numbers from the distribution number 1 to the distribution number 64 is one model set. Likewise, a set of states S2 having the seven types of distribution numbers from the distribution number 1 to the distribution number 64 is one model set.

Therefore, in the present invention, the description length li(χ^{N}) defined by the aforementioned Equation 1 refers to the description length li(χ^{N}) of the I-th type of state(denoted by the state i) when the type of the distribution number in an arbitrary state is set to the i-th type of 1, . . . , i, . . . , I, and is defined as the following equation.

[Equation 2]

$${l}_{i} ( {x}^{N} ) = - log {P}_{\hat{θ} ( i )} ( {x}^{N} ) + α ( \frac{{β}_{i}}{2} log N ) \qquad ( 2 )$$

θ(i): parameter of state i

θ⁽ⁱ⁾=maximum likelihood estimate of θ₁⁽ⁱ⁾, . . . , θ_{βi}⁽ⁱ⁾

The Equation 2 is different from the Equation 1 in that log I of the third term, which is the final term on the right side of the aforementioned Equation 1, is a constant, and thus is omitted, and in that (βi/2) log N which is the second term on the right side of Equation 1 is multiplied by the weighting coefficient α. Furthermore, in the aforementioned Equation 2, log I of the third term, which is the final term on the right side of the Equation 1, is omitted, but it may not be omitted and may remain as it is.

Furthermore, βi is a dimension (the number of free parameters) of the state i having the i-th distribution number and is denoted as a dimension number of distribution number×feature vector. However, the dimension number of the feature vector is cepstrum (CEP) dimension number+Δ cepstrum (CEP) dimension number+Δ power (POW) dimension number.

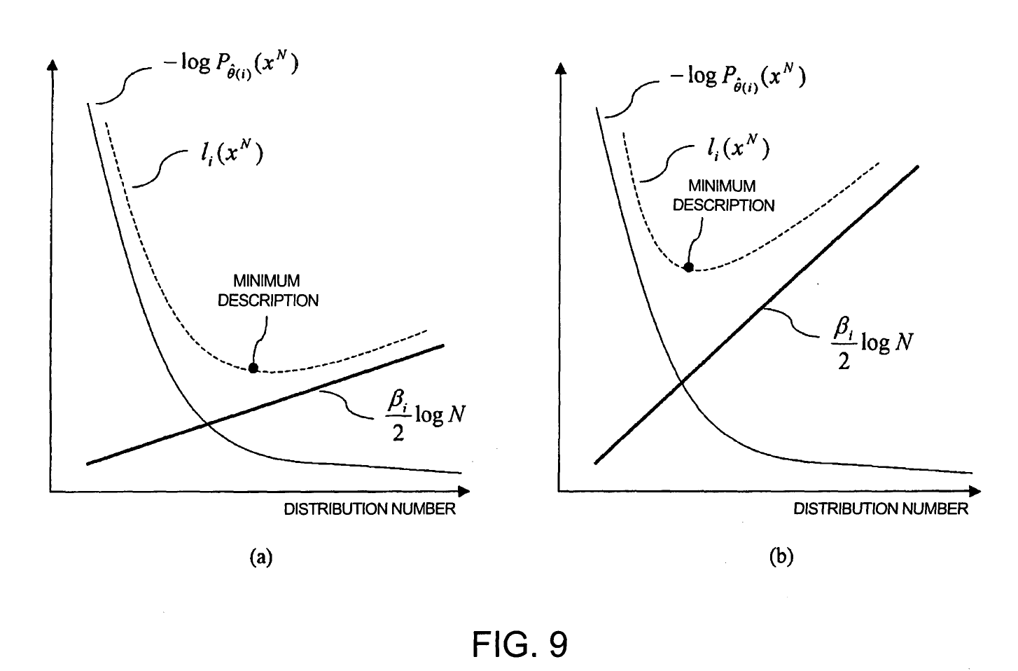

Furthermore, α is a weighting coefficient for adjusting the optimal distribution number, and α can be varied to change the description length li(χ^{N}). That is, as shown in FIGS. 9(a) and 9(b), simply thinking, the first term on the right side of Equation 2 decreases (represented by a narrow solid line) as the distribution number increases, the second term on the right side of Equation 2 increases monotonously (represented by a thick solid line) as the distribution number increases, and the description length li(χ^{N}) obtained from the sum of the first term and the second term has the value as shown in a dashed line.

Therefore, since varying a makes the slope of the monotone increasing of the second term variable (the slope increases as a increases), the description length li(χ^{N}) obtained from the sum of the first term and the second term on the right side of Equation 2 can be changed by varying the value of α. By doing so, for example, if α increases, the linear graph shown in FIG. 9(a) changes to the graph shown in FIG. 9(b), and as the distribution number is smaller, the description length li(χ^{N}) can be adjusted to be minimum.

Furthermore, the state i having the i-th type of distribution number in Equation 2 corresponds to M number of data (M data composed of the predetermined number of frames). That is, if the length (the number of frames) of data 1 is n1, the length (the number of frames) of data 2 is n2, and the length (the number of frames) of data M is nM, the first term on the right side of Equation 2 is represented as the following Equation 3 since N of χ^{N} is represented as N=n1+n2+ . . . +nM.

Furthermore, the data 1, the data 2, . . . , the data M are data (for example, as described with reference to FIG. 4, the data are the training speech data corresponding to the interval t1 or the interval t11 if the state i is the state S0 in the syllable HMM of /a/ having the distribution number 64) corresponding to the predetermined intervals of the plurality of the training speech data 1 matching to the state i.

[Equation 3]

logP_{\hat{θ}(i)}(χ^{N})=logP_{\hat{θ}(i)}(χⁿ^{₁})+logP_{\hat{θ}(i)}(χⁿ^{₂})+ . . . +logP_{\hat{θ}(i)}(χⁿ^{_{M}}) (3)

In Equation 3, each term on the right side is a likelihood for the data of the interval corresponding to the state i having the i-th type of distribution number, but in this embodiment, is an output probability for the data of the interval corresponding to the state i. Furthermore, the output probability is substantially expressed as a sum of output probabilities corresponding to a plurality of the frames constituting the data corresponding to the state i.

On the other hand, in the description length li(χ^{N}) obtained from the aforementioned Equation 2, a model the description length li(χ^{N}) of which is minimum refers to as the optimal model. That is, a state in which an arbitrary syllable HMM has the distribution number the description length li(χ^{N}) of which is minimum is the optimal state.

That is, since this embodiment includes the types of the distribution numbers of 1, 2, 4, 8, 16, 32 and 64, the seven types of description length li(χ^{N}) in an arbitrary state are obtained. That is, the description length 11(χ^{N}) of the state of the distribution number 1 (the first type of distribution number), the description length 12(χ^{N}) of the state of the distribution number 2 (the second type of distribution number), the description length 13(χ^{N}) of the state of the distribution number 4 (the third type of distribution number), the description length 14(χ^{N}) of the state of the distribution number 8 (the fourth type of distribution number), the description length 15(χ^{N}) of the state of the distribution number 16 (the fifth type of distribution number), the description length 16(χ^{N}) of the state of the distribution number 32 (the sixth type of distribution number), and the description length 17(χ^{N}) of the state of the distribution number 64 (the seventh type of distribution number) are obtained. And then, the state i having the distribution number the description length of which is minimum is selected among them.

For example, in the example of FIG. 8, considering the syllable HMMs of /a/, the description length of the respective states S0, S1 and S2 of the distribution numbers 1 to 64 (the maximum distribution number) is computed using Equation 2. Then, if the state the description length of which is minimum is selected, as described above, FIG. 8 shows an example in which the state S0 having the distribution number 2 is selected from the states S0 since the state S0 of the distribution number 2 has the minimum distribution length, the state S1 of the distribution number 64 is selected from the states S1 since the state S1 of the distribution number 64 has the minimum distribution length, and the state S2 of the distribution number 1 is selected from the states S2 since the state S2 of the distribution number 1 has the minimum distribution length.

As described above, the description length li(χ^{N}) of the respective states (in this embodiment, the states S0, S1 and S2) in the respective syllable HMMs of the distribution numbers 1 to 64 (the maximum distribution number) is computed using Equation 2, and it is determined which of the respective states of the distribution numbers 1 to 64 has the minimum description length to select the state the description length of which is minimum. Then, the syllable HMM is constructed for every syllable in accordance with the state having the distribution number the description length of which is minimum.

By doing so, when the HMM having the optimized distribution number is constructed for the respective states of the respective syllable HMMs, all parameters of the HMMs are retrained using the training speech data 1 by the maximum likelihood estimation method. As a result, as for the respective states of the respective syllable HMMs, the optimized distribution number and the optimal parameters can be obtained.

In the respective states of the respective syllable HMMs in which the optimized distribution number and the optimal parameters are obtained, since the distribution number of the respective states in the respective syllable HMMs is optimized, sufficient recognition ability can be secured, and since the number of parameters can be substantially reduced as compared with a case where all states have the same distribution number, it is possible to reduce the amount of computation and the required memory capacity, and to increase a processing speed. In addition, it is possible to lower costs and power consumptions.

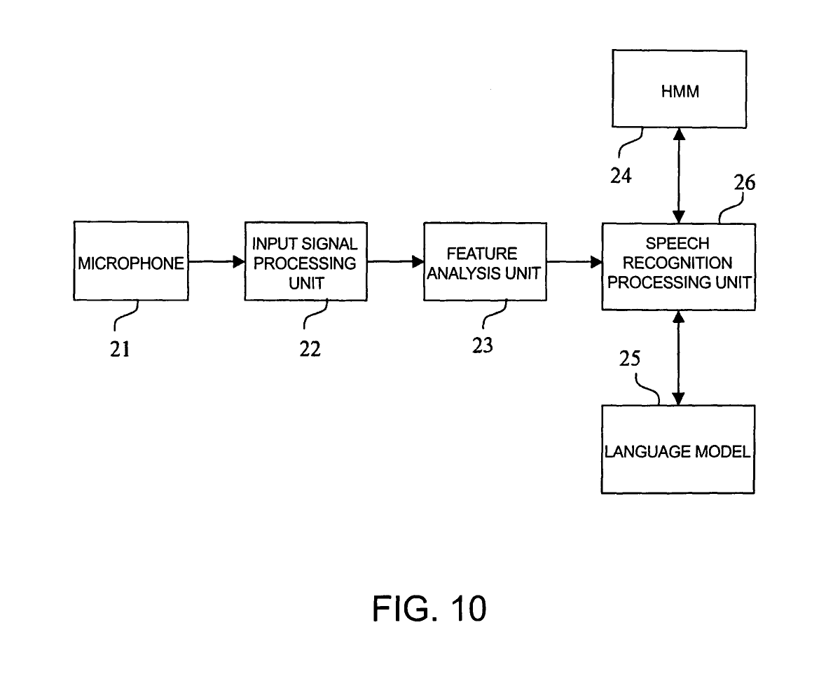

FIG. 10 is a view illustrating a construction of a speech recognition device using the acoustic models (HMM models) as describe above. The speech recognition device can include a speech inputting microphone 21, an input signal processing unit 22 for amplifying the speech inputted from the microphone 21 and converting the input speech into digital signals, a feature analysis unit 23 for extracting the feature data (feature vector) from the speech signals digitally converted by the input signal processing unit, and a speech recognition processing unit 26 for speech-recognizing the feature data outputted from the feature analysis unit 23 using HMM models 24 or language models 25. The HMM models (the syllable HMM sets 10 can have the optimal distribution number for every state shown in FIG. 1) created using the acoustic model creating method described above can be used as the HMM models 24.

Like this, since in each syllable HMM (for example, the syllable HMMs for the respective 124 syllables), the respective states constituting the syllable HMM is composed of the syllable model having the optimal distribution number, the speech recognition device can substantially reduce the number of parameters of each syllable HMM while maintaining high recognition ability. As a result, since it is possible to reduce the amount of computation and the usable memory capacity and to increase a processing speed. Furthermore, it is possible to lower costs and power consumptions. Thus, the speech recognition device is usefully applicable to a small-sized and low-cost system having large restrictions on hardware resources thereof.

For example, a recognition test is executed using the speech recognition device using the syllable HMM sets 10, which have the optimal distribution numbers for the respective states, according to the present invention. As a result of performing a sentence recognition test for 124 syllable HMMs, the conventional recognition rate for the total distribution numbers of about 19,000 is 94.6%, but the recognition rate for the total distribution numbers of about 7,000, which are the optimized distribution numbers by the present invention, becomes 94.4%. Thus, it can be confirmed that the recognition ability can be maintained even when the total distribution numbers are reduced to about ⅓.

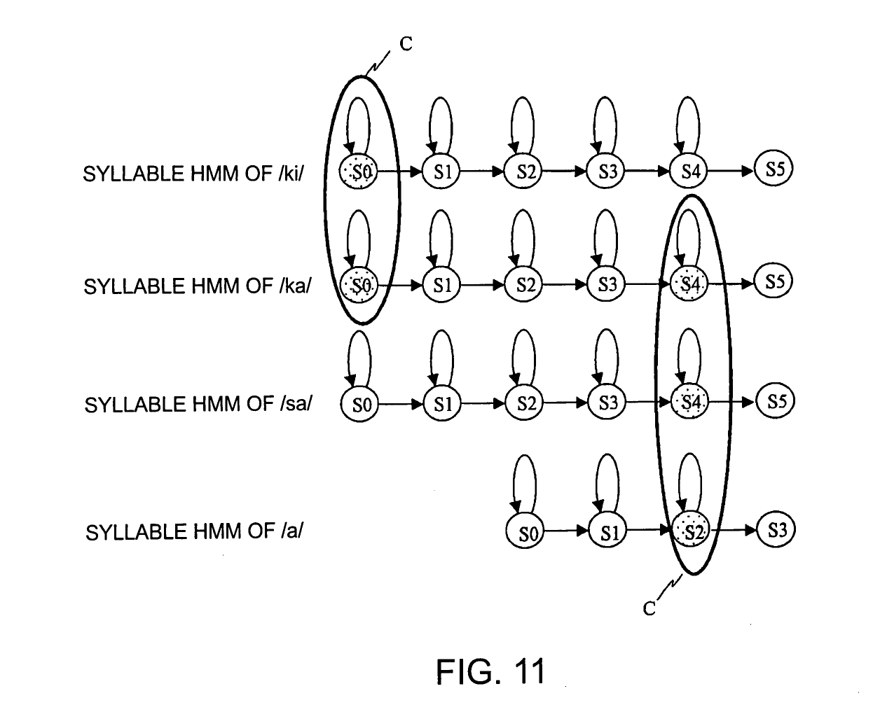

In a second embodiment, in the syllable HMMs having the same consonant or the same vowel, the syllable HMMs (hereinafter, referred to as the state tying syllable HMMs for convenience) tying, for example, an initial state or a final state of the plural states (the states having the self loop) constituting the syllable HMMs are constructed, and the technology described the aforementioned first embodiment, that is, the technology for optimizing the distribution number of the respective states of the respective syllable HMMs applies to the state tying syllable HMMs. Now, it will be described with reference to FIG. 11.

Herein, for example, the syllable HMMs of /ki/, the syllable HMMs of /ka/, the syllable HMMs of /sa/, and the syllable HMMs of /a/ are considered as the syllable HMMs having the same consonant or the same vowel. That is, the syllable /ki/ and the syllable /ka/ all have the consonant /k/, and the syllable /sa/ and the syllable /a/ all have the vowel /a/.

Therefore, in the syllable HMMs having the same consonant, the state existing in the front end (here, referred to as a first state) is tied in each syllable HMM, and in the syllable HMMs having the same vowel, the state existing in the rear end (here, referred to as a final state of the states having a self loop) is tied in each syllable HMM.

FIG. 11 is a view illustrating that the first state S0 of the syllable HMM of /ki/ and the first state S0 of the syllable HMM of /ka/ are tied, and the final state S4 of the syllable HMM of /ka/, the final state S4 having the self loop of the syllable HMM of /sa/ and the final state S2 having the self loop of the syllable HMM of /a/ are tied. Each tied state is surrounded with an elliptical frame C shown in a thick solid line.

Like this, if the state tying is performed on the syllable HMMs having the same consonant or the same vowel, the tied states have the same parameter. Thus, they are treated as the same parameter in performing the HMM training (the maximum likelihood estimation).

For example, when as for a speech data “KAKI”, the HMM is constructed by connecting the syllable HMM of /ka/ composed of five states of S0, S1, S2, S3 and S4 having the self loop with the syllable HMM of /ki/ composed of five states of S0, S1, S2, S3 and S4 having the self loop, the first state S0 of the syllable HMM of /ka/ and the first state S0 of the syllable HMM of /ki/ are tied. Thus, the state S0 of the syllable HMM of /ka/ and the state S0 of the syllable HMM of /ki/ are treated to have the same parameter, and thus the states S0 are trained at the same time.

The number of parameters can be reduced by the state tying, and as a result, the reduction of required memory capacity and the reduction in the amount of computation can be accomplished, so that it is applicable to a CPU having low processing ability, and thus low power consumption can be accomplished. Therefore, it is applicable to a system requiring low costs. Furthermore, in the syllable having the small amount of the training speech data, it is possible to prevent the deterioration of the recognition ability due to over-training in accordance with a reduction in the number of parameters.

Like this, by performing the state tying, in the syllable HMM of/ki/ and the syllable HMM of /ka/ chosen from this example, the HMM is constructed by tying the first states S0. Furthermore, in the syllable HMM of /ka/, the syllable HMM of /sa/, and the syllable HMM of /a/, the HMM is constructed by tying the final states (in the example of FIG. 11, the state S4 of the syllable HMM of /ka/, the state S4 of the syllable HMM of /sa/, and the state S2 of the syllable HMM of /a/).

Then, the optimization of distribution number is performed on the respective tying states of the respective syllable HMMs as described above using the MDL criterion described in the aforementioned first embodiment.

Like this, in the second embodiment, as for the syllable HMMs having the same consonant or the same vowel, the state-tying syllable HMMs are constructed by tying, for example, the first state and the final state of the plural states constituting the syllable HMMs, and the technology described in the aforementioned first embodiment is applied to the state-tying syllable HMMs. Thus, it is possible to further reduce the number of parameters, and as a result, it is possible to reduce the amount of computation and the required memory capacity, and to increase a processing speed, thereby lowering costs and power consumptions. Furthermore, the syllable HMM, in which the respective states have the optimized distribution numbers and the optimal parameters, can be constructed.

Therefore, as for the respective syllable HMMs tying the states, the optimal distribution numbers are created for the respective states as described in the aforementioned first embodiment, and the syllable HMMs are applied to the speech recognition device as shown in FIG. 10. Thus, it is possible to further reduce the number of parameters of the respective syllable HMMs while maintaining high recognition ability. By doing so, it is possible to reduce the amount of computation and the required memory capacity and to increase a processing speed, thereby lowering costs and power consumptions. Thus, since the speech recognition device can be mounted to a small-sized and inexpensive system requiring low cost and having many restrictions on hardware resources thereof, the speech recognition device of the present invention is considerably useful.

Furthermore, in the aforementioned example of the state tying, although in the syllable HMMs having a same consonant or a same vowel, an example of tying the first state and the final state of the plural states constituting the syllable HMMs is described, the plural states may be tied, respectively. That is, in the syllable HMMs having a same consonant, an initial state or at least two states (for example, the initial state and the second state) including an initial state in the syllable HMMs are tied, and in the syllable HMMs having a same vowel, the final state or at least two states (for example, the final state and a state right before the final state) including the final state of the states having the self loop in the syllable HMMs are tied. By doing so, it is possible to further reduce the number of parameters.

In the plural states constructing the syllable HMMs as shown in FIG. 11, the first state S0, which is an initial state, and the second state S1 of the syllable HMM of /ki/, and the first state S0, which is an initial state, and the second state S1 of the syllable HMM of /ka/ are tied, and the final state S4 and the fourth state S3 right before the final state of the syllable HMM of /ka/, the final state S4 and the state S3 right before the final state of the syllable HMM of /sa/, and the final state S2 and the state S1 right before the final state of the syllable HMM of /a/ are tied, respectively. Each of the tied states is surrounded with an elliptical frame C shown in a thick solid line.

Furthermore, it should be understood that the present invention is not limited to the aforementioned embodiments, and that changes and modifications may be made without departing from the spirit and scope of the present invention. For example, the aforementioned second embodiment describes that the states of a same consonant or a same vowel are tied when connecting the syllable HMMs. However, for example, when the syllable HMMs are constructed by connecting phoneme HMMs, it is possible to tie the distributions of the state for the same vowel in the same manner.

For example, the phoneme HMM of /k/, the phoneme HMM of /s/, and the phoneme HMM of /a/ exist, and when the syllable HMM of /ka/ is constructed by connecting the phoneme HMM of /k/ with the phoneme HMM of /a/ and the syllable HMM of /sa/ is constructed by connecting the phoneme HMM of /s/ with the phoneme HMM of /a/, the vowels /a/ of the newly constructed syllable HMM of /ka/ and syllable HMM of /sa/ are the same. Therefore, the portions corresponding to the phonemes /a/ in the syllable HMM of /ka/ and the syllable HMM of /sa/ tie the distributions of the respective states of the phoneme HMM of /a/.

In addition, the optimization of the distribution number described in the first embodiment is performed on the respective states of the syllable HMM of /ka/ and the syllable HMM of /sa/ which tie the distributions of the same vowel as described above. As a result of the optimization, in the syllable HMMs which tie the distributions (in the example, the syllable HMM of /ka/ and the syllable HMM of /sa/), the distribution numbers of the distribution-tying portions (in the example, the state having the self loop of the phoneme /a/) are equalized in the syllable HMM of /ka/ and the syllable HMM of /sa/.

As described above, tying the distributions makes the number of parameters in the respective syllable HMMs considerably reduced. As a result, the amount of computation or the required memory capacity can be further reduced. In addition, the same effects as the case of the aforementioned state tying can be obtained.

Furthermore, according to the present invention, a processing program in which the processing orders for implementing the aforementioned present invention are described can be prepared and recorded in a recording medium, such as a floppy disk, an optical disk, and a hard disk. Thus, the present invention can have the recording medium in which the processing program is recorded. Furthermore, the processing program can be obtained through networks.

As described above, according to the acoustic model creating method of the present invention, in order to optimize the Gaussian distribution numbers for the respective states, the distribution numbers from a predetermined value to the maximum distribution number can be set for a plurality of the states constituting the HMM. As for the distribution numbers set from the predetermined value to the maximum distribution number, which distribution number is optimal out of the distribution numbers from the predetermined value to the maximum distribution number can be selected using the Minimum Description Length criterion. Each HMM can be constructed in accordance with the selected state having the distribution number the description length of which is minimum. The constructed HMM can be retrained using the training speech data. By doing so, it is possible to set the optimal distribution number using a smaller amount of computation, and it is also possible to create the HMM having high recognition ability using the smaller amount of computation.

Specifically, in the present invention, the optimal distribution number is selected from the distribution numbers from the predetermined value to the maximum distribution number. For example, if the seven types of the distribution numbers are used in a predetermined state, the computation for obtaining the description length is performed seven times in one state, and then the state the description length of which is minimum is selected from them. Thus, it is possible to set the optimal distribution numbers with a small amount of computation.

Furthermore, the speech recognition device according to the present invention uses the acoustic model (HMM) created by the acoustic model creating method of the present invention described above. That is, since the HMM is composed of the syllable models including the respective syllables, which have the optimal distribution numbers for the plurality of the states constituting the HMM, it is possible to further reduce the number of parameters of the respective syllable HMMs without deteriorating the recognition ability as compared with the HMM in which all states of a number of the distribution numbers are constant. Therefore, it is possible to reduce the amount of computation and the required memory capacity and to increase a processing speed. Furthermore, it is possible to lower costs and power consumptions. Thus, since the speech recognition device can be mounted to a small-sized and inexpensive system having many restrictions on hardware resources, the speech recognition device of the present invention is considerably useful.

While this invention has been described in conjunction with specific embodiments thereof, it is evident that many alternatives, modifications, and variations will be apparent to those skilled in the art. Accordingly, preferred embodiments of the invention as set forth herein are intended to be illustrative, not limiting. Various changes may be made without departing from the spirit and scope of the invention.

What is claimed is:

1. An acoustic model creating method of creating an HMM (Hidden Markov Model) by optimizing, for each state, Gaussian distribution numbers of the respective states constituting the HMM and retraining the optimized HMM using training speech data, the method comprising:
setting plural types of the Gaussian distribution numbers from a predetermined value to a maximum distribution number for each of the plurality of states constituting the HMM;
computing a description length for each of the plurality of states having the plural types of Gaussian distribution numbers using a Minimum Description Length criterion;
selecting a state having the Gaussian distribution number whose description length is minimum, for every state; and
constructing the HMM in accordance with the state having the Gaussian distribution number whose description length is minimum, selected for every state, and retraining the constructed HMM using the training speech data.

2. An acoustic model creating method according to claim 1, wherein, for the Minimum Description Length criterion, a description length li(χ^{N}) using a model i when a model set {1, . . . , i, . . . , I} and data χ^{N}={χ₁, . . . , χ_{N}} (N being a data length) are given is expressed as the following general equation,
$${l}_{i} ( {x}^{N} ) = - log {P}_{\hat{θ} ( i )} ( {x}^{N} ) + \frac{{β}_{i}}{2} log N + log I$$
θ(i): parameter of model i
θ⁽ⁱ⁾=maximum likelihood estimate of θ₁⁽ⁱ⁾, . . . , θ_{βi}⁽ⁱ⁾
βi: dimension (degree of freedom) of model i
and in the general equation that computes the description length, the model set {1, . . . , i, . . . , I} is considered as a set of states in which plural types of the Gaussian distribution numbers from a predetermined value to the maximum distribution number are set for a predetermined state in a predetermined HMM, where, when the number of types of the Gaussian distribution numbers is I (I is an integer satisfying I≦2), then 1, . . . , i, . . . , I are symbols that specify the respective distribution number types from a first type to an I-th type, and the general equation is used as an equation for computing the description length of the state having an i-th type of distribution number out of 1, . . . , i, . . . , I.

3. An acoustic model creating method according to claim 2, in the general equation that computes the description length, the second term on the right side of the equation being multiplied by a weighting coefficient α.

4. An acoustic model creating method according to claim 2, in the general equation that computes the description length, the second term on the right side of the equation being multiplied by the weighting coefficient α, and the third term on the right side being omitted.

5. An acoustic model creating method according to claim 2, the data χ^{N} being a set of the respective training speech data obtained by matching in time series a plurality of the training speech data with the respective states of the HMMs for every state, using the HMMs in which the respective states have any one of the Gaussian distribution numbers from the predetermined value to the maximum distribution number.

6. An acoustic model creating method according to claim 5, the any one of the Gaussian distribution numbers being the maximum distribution number.

7. An acoustic model creating method according to claim 1, the HMMs being syllable HMMs.

8. An acoustic model creating method according to claim 7, wherein, for a plurality of syllable HMMs having a same consonant or a same vowel in the syllable HMMs, the syllable HMMs having the same consonant out of the states constituting the syllable HMMs tie an initial state or at least two states including an initial state in the syllable HMMs, and the syllable HMMs having the same vowel tie a final state of the states having self loops or at least two states including the final state in the syllable HMMs.

9. A speech recognition device that recognizes input speech using HMMs (Hidden Markov Models) as acoustic models for feature data obtained by feature analysis of the input speech,
the HMMs created by the acoustic model creating method according to claim 1 being used as the HMMs which are the acoustic models.
